(19) United States
(12) Patent Application Publication
(10) Pub. No.: US 2020/0259783 A1
(43) Pub. Date: Aug. 13, 2020

(54) METHOD AND APPARATUS FOR DETERMINING ETHERNET MAC ADDRESS

(71) Applicant: HUAWEI TECHNOLOGIES CO., LTD., SHENZHEN (CN)

(72) Inventors: Changchun XU, Shanghai (CN); Zhongping CHEN, Shanghai (CN); Yuan WANG, Shanghai (CN); Yan WANG, Shanghai (CN)

(21) Appl. No.: 16/862,332

(22) Filed: Apr. 29, 2020

Related U.S. Application Data
(63) Continuation of application No. PCT/CN2018/104028, filed on Sep. 4, 2018.

(30) Foreign Application Priority Data
Oct. 31, 2017 (CN) 201711046277.8

(51) Int. Cl. H04L 29/12

(52) U.S. Cl. CPC H04L 61/20; H04L 61/6022

(57) ABSTRACT

This application provides a method and an apparatus for determining an ethernet MAC address. The method includes: receiving, by a first network device, a first ethernet MAC address from a terminal; and determining, by the first network device, whether the first ethernet MAC address can uniquely identify the terminal or a PDU session of the terminal within a global network range, and sending indication information to the terminal based on a determining result, where the indication information is used to determine a source MAC address of a packet sent by the terminal, and the source MAC address is an ethernet MAC address that can uniquely identify the terminal or the PDU session of the terminal within the global network range.

### CROSS-REFERENCE TO RELATED APPLICATIONS

This application is a continuation of International Application No. PCT/CN2018/104028, filed on Sep. 4, 2018, which claims priority to Chinese Patent Application No. 201711046277.8, filed on Oct. 31, 2017. The disclosures of the aforementioned applications are hereby incorporated by reference in their entireties.

### TECHNICAL FIELD

This application relates to the field of communications technologies, and in particular, to a method and an apparatus for determining an ethernet media access control (MAC) address.

### BACKGROUND

Currently, on a 3rd generation partnership project (3GPP) core network user plane (UP), a packet is forwarded based on an internet protocol (IP) address of the packet. A 5th generation (5G) wireless communications technology can support transmission of an ethernet frame. In an ethernet scenario, if an ethernet frame carries an IP packet, an IP address may be private and variable, and IP addresses of a plurality of terminals may conflict with each other. Consequently, if the IP address of the terminal is used as a basis for forwarding the packet, an error occurs in packet forwarding.

### SUMMARY

Embodiments of this application provide a method and an apparatus for determining an ethernet MAC address, to resolve a problem of a packet forwarding error caused by forwarding a packet by using an IP address of a terminal in an ethernet scenario.

To achieve the foregoing objective, the embodiments of this application provide the following technical solutions.

According to a first aspect, a method for determining an ethernet MAC address is provided. The method includes: receiving, by a first network device, a first ethernet MAC address from a terminal; and determining, by the first network device, whether the first ethernet MAC address can uniquely identify the terminal or a PDU session of the terminal within a global network range, and sending indication information to the terminal based on a determining result, where the indication information is used to determine a source MAC address of a packet sent by the terminal, and the source MAC address is an ethernet MAC address that can uniquely identify the terminal or the PDU session of the terminal within the global network range. According to the method provided in the first aspect, the first network device determines the first ethernet MAC address generated by the terminal and sends the indication information to the terminal, and the terminal determines the source MAC address of the packet based on the indication information. Because the source MAC address is an ethernet MAC address that can uniquely identify the terminal or the PDU session of the terminal within the global network range, one terminal can be uniquely determined based on the ethernet MAC address, and ethernet MAC addresses corresponding to different terminals do not conflict with each other. Therefore, when packet forwarding is performed based on the ethernet MAC address that can uniquely identify the terminal or the PDU session of the terminal, correctness of packet forwarding can be ensured.

In one embodiment, the determining, by the first network device, whether the first ethernet MAC address can uniquely identify the terminal or a PDU session of the terminal within a global network range, and sending indication information to the terminal based on a determining result includes: if the first ethernet MAC address cannot uniquely identify the terminal or the PDU session of the terminal within the global network range, the indication information includes a second ethernet MAC address, where the second ethernet MAC address can uniquely identify the terminal or the PDU session of the terminal within the global network range; or the indication information indicates that the first ethernet MAC address cannot uniquely identify the terminal or the PDU session of the terminal within the global network range; or if the first ethernet MAC address can uniquely identify the terminal or the PDU session of the terminal within the global network range, the indication information includes the first ethernet MAC address, or the indication information indicates that the first ethernet MAC address can uniquely identify the terminal or the PDU session of the terminal within the global network range. The second ethernet MAC address may be an ethernet MAC address allocated by the first network device to the terminal.

In one embodiment, the indication information includes the second ethernet MAC address, and the method further includes: sending, by the first network device, the second ethernet MAC address to a second network device, where the second ethernet MAC address is used to establish a correspondence between the second ethernet MAC address and an identifier of a subscriber corresponding to the terminal, and the correspondence is used to generate a bill of the subscriber. In this possible design, one ethernet MAC address corresponds only to one terminal or one PDU session of one terminal, and ethernet MAC addresses corresponding to different terminals do not conflict with each other, so that when the bill of the subscriber is generated based on the ethernet MAC address that can uniquely identify the terminal or the PDU session of the terminal, correctness of the generated bill may be ensured.

In one embodiment, the indication information includes the second ethernet MAC address, and the method further includes: establishing, by the first network device, a correspondence between the second ethernet MAC address and an identifier of a subscriber corresponding to the terminal; and sending, by the first network device, the correspondence to a third network device, where the correspondence is used to generate a bill of the subscriber. In this possible design, one ethernet MAC address corresponds only to one terminal or one PDU session of one terminal, and ethernet MAC addresses corresponding to different terminals do not conflict with each other, so that when the bill of the subscriber is generated based on the ethernet MAC address that can uniquely identify the terminal or the PDU session of the terminal, correctness of the generated bill may be ensured.

In one embodiment, the indication information includes the second ethernet MAC address, and the method further includes: setting, by the first network device, that the second ethernet MAC address in an ethernet MAC address database cannot be allocated.

In one embodiment, the indication information includes the first ethernet MAC address, or the indication information indicates that the first ethernet MAC address can uniquely identify the terminal or the PDU session of the terminal within the global network range, and the method further includes: sending, by the first network device, the first ethernet MAC address to a second network device, where the first ethernet MAC address is used to establish a correspondence between the first ethernet MAC address and an identifier of a subscriber corresponding to the terminal, and the correspondence is used to generate a bill of the subscriber. In this possible design, one ethernet MAC address corresponds only to one terminal or one PDU session of one terminal, and ethernet MAC addresses corresponding to different terminals do not conflict with each other, so that when the bill of the subscriber is generated based on the ethernet MAC address that can uniquely identify the terminal or the PDU session of the terminal, correctness of the generated bill may be ensured.

In one embodiment, the indication information includes the first ethernet MAC address, or the indication information indicates that the first ethernet MAC address can uniquely identify the terminal or the PDU session of the terminal within the global network range, and the method further includes: establishing, by the first network device, a correspondence between the first ethernet MAC address and an identifier of a subscriber corresponding to the terminal; and sending, by the first network device, the correspondence to a third network device, where the correspondence is used to generate a bill of the subscriber. In this possible design, one ethernet MAC address corresponds only to one terminal or one PDU session of one terminal, and ethernet MAC addresses corresponding to different terminals do not conflict with each other, so that when the bill of the subscriber is generated based on the ethernet MAC address that can uniquely identify the terminal or the PDU session of the terminal, correctness of the generated bill may be ensured.

In one embodiment, the indication information includes the first ethernet MAC address, or the indication information indicates that the first ethernet MAC address can uniquely identify the terminal or the PDU session of the terminal within the global network range, and the method further includes: setting, by the first network device, that the first ethernet MAC address in an ethernet MAC address database cannot be allocated.

In one embodiment, a type of the PDU session of the terminal is an ethernet type.

According to a second aspect, a method for determining an ethernet MAC address is provided. The method includes: allocating, by a first network device, a third ethernet MAC address to a terminal, where the third ethernet MAC address can uniquely identify the terminal or a PDU session of the terminal within a global network range; and sending, by the first network device, the third ethernet MAC address to the terminal, where the third ethernet MAC address is a source MAC address of a packet sent by the terminal. According to the method provided in the second aspect, the first network device allocates the third ethernet MAC address to the terminal, and the terminal determines that the third ethernet MAC address is the source MAC address of the packet sent by the terminal. Because the third ethernet MAC address is an ethernet MAC address that can uniquely identify the terminal or the PDU session of the terminal within the global network range, one terminal can be uniquely determined based on the third ethernet MAC address, and ethernet MAC addresses corresponding to different terminals do not conflict with each other. Therefore, when packet forwarding is performed based on the third ethernet MAC address, correctness of packet forwarding can be ensured.

In one embodiment, before the allocating, by a first network device, a third ethernet MAC address to a terminal, the method further includes: receiving, by the first network device, a fourth ethernet MAC address from the terminal; and determining, by the first network device, that the fourth ethernet MAC address cannot uniquely identify the terminal or the PDU session of the terminal within the global network range. In this possible design, the first network device may allocate the third ethernet MAC address to the terminal when determining that the fourth ethernet MAC address generated by the terminal cannot uniquely identify the terminal or the PDU session of the terminal within the global network range.

In one embodiment, the method further includes: sending, by the first network device, the third ethernet MAC address to a second network device, where the third ethernet MAC address is used to establish a correspondence between the third ethernet MAC address and an identifier of a subscriber corresponding to the terminal, and the correspondence is used to generate a bill of the subscriber. In this possible design, one ethernet MAC address corresponds only to one terminal or one PDU session of one terminal, and ethernet MAC addresses corresponding to different terminals do not conflict with each other, so that when the bill of the subscriber is generated based on the ethernet MAC address that can uniquely identify the terminal or the PDU session of the terminal, correctness of the generated bill may be ensured.

In one embodiment, the method further includes: establishing, by the first network device, a correspondence between the third ethernet MAC address and an identifier of a subscriber corresponding to the terminal; and sending, by the first network device, the correspondence to a third network device, where the correspondence is used to generate a bill of the subscriber. In this possible design, one ethernet MAC address corresponds only to one terminal or one PDU session of one terminal, and ethernet MAC addresses corresponding to different terminals do not conflict with each other, so that when the bill of the subscriber is generated based on the ethernet MAC address that can uniquely identify the terminal or the PDU session of the terminal, correctness of the generated bill may be ensured.

In one embodiment, the method further includes: setting, by the first network device, that the third ethernet MAC address in an ethernet MAC address database cannot be allocated.

In one embodiment, a type of the PDU session of the terminal is an ethernet type.

According to a third aspect, a method for determining an ethernet MAC address is provided. The method includes: generating, by a terminal, a first ethernet MAC address; sending, by the terminal, the first ethernet MAC address to a first network device; receiving, by the terminal, indication information from the first network device, where the indication information is associated with whether the first ethernet MAC address can uniquely identify the terminal or a PDU session of the terminal within a global network range; and determining, by the terminal, a source MAC address of a packet based on the indication information, and sending the packet based on the source MAC address, where the source MAC address is an ethernet MAC address that can uniquely identify the terminal or the PDU session of the terminal within the global network range. According to the method provided in the third aspect, the terminal generates the first ethernet MAC address and sends the first ethernet MAC address to the first network device, the first network device sends the indication information to the terminal, and the terminal determines the source MAC address of the packet based on the indication information. Because the source MAC address is an ethernet MAC address that can uniquely identify the terminal or the PDU session of the terminal within the global network range, one terminal can be uniquely determined based on the ethernet MAC address, and ethernet MAC addresses corresponding to different terminals do not conflict with each other. Therefore, when packet forwarding is performed based on the ethernet MAC address that can uniquely identify the terminal or the PDU session of the terminal, correctness of packet forwarding can be ensured.

In one embodiment, the indication information indicates that the first ethernet MAC address cannot uniquely identify the terminal or the PDU session of the terminal within the global network range; or the indication information indicates that the first ethernet MAC address can uniquely identify the terminal or the PDU session of the terminal within the global network range.

In one embodiment, the determining, by the terminal, a source MAC address of a packet based on the indication information includes: if the indication information includes a second ethernet MAC address, where the second ethernet MAC address can uniquely identify the terminal or the PDU session of the terminal within the global network range, determining, by the terminal, that the source MAC address is the second ethernet MAC address; or if the indication information includes the first ethernet MAC address, determining, by the terminal, that the source MAC address is the first ethernet MAC address. The second ethernet MAC address may be an ethernet MAC address allocated by the first network device to the terminal.

In one embodiment, before the generating, by a terminal, a first ethernet MAC address, the method further includes: generating, by the terminal, a fifth ethernet MAC address, and sending the fifth ethernet MAC address to the first network device; and receiving, by the terminal from the first network device, information used to indicate that the fifth ethernet MAC address cannot uniquely identify the terminal or the PDU session of the terminal within the global network range.

In one embodiment, a type of the PDU session of the terminal is an ethernet type.

According to a fourth aspect, a method for determining an ethernet MAC address is provided. The method includes: receiving, by a terminal, a third ethernet MAC address from a first network device, where the third ethernet MAC address can uniquely identify the terminal or a PDU session of the terminal within a global network range; and sending, by the terminal, a packet, where a source MAC address of the packet is the third ethernet MAC address. According to the method provided in the fourth aspect, the terminal determines that the third ethernet MAC address sent by the first network device is the source MAC address of the packet sent by the terminal. Because the third ethernet MAC address is an ethernet MAC address that can uniquely identify the terminal or the PDU session of the terminal within the global network range, one terminal can be uniquely determined based on the third ethernet MAC address, and ethernet MAC addresses corresponding to different terminals do not conflict with each other. Therefore, when packet forwarding is performed based on the third ethernet MAC address, correctness of packet forwarding can be ensured.

In one embodiment, a type of the PDU session of the terminal is an ethernet type.

According to a fifth aspect, a method for generating a bill is provided. The method includes: receiving, by a second network device, an ethernet MAC address from a first network device, where the ethernet MAC address can uniquely identify a terminal or a PDU session of the terminal within a global network range, and the ethernet MAC address is a source MAC address of a packet of the terminal; establishing, by the second network device, a correspondence between the ethernet MAC address and an identifier of a subscriber corresponding to the terminal; and sending, by the second network device, the correspondence to a third network device, where the correspondence is used to generate a bill of the subscriber. According to the method provided in the fifth aspect, one ethernet MAC address corresponds only to one terminal or one PDU session of one terminal, and ethernet MAC addresses corresponding to different terminals do not conflict with each other, so that when the bill of the subscriber is generated based on the ethernet MAC address that can uniquely identify the terminal or the PDU session of the terminal, correctness of the generated bill may be ensured.

According to a sixth aspect, a method for generating a bill is provided. The method includes: receiving, by a third network device from a second network device or a first network device, a correspondence between an ethernet MAC address and an identifier of a subscriber corresponding to a terminal, where the ethernet MAC address can uniquely identify the terminal or a PDU session of the terminal within a global network range, and the ethernet MAC address is a source MAC address of a packet of the terminal; and generating, by the third network device, a bill of the subscriber based on the correspondence. According to the method provided in the sixth aspect, one ethernet MAC address corresponds only to one terminal or one PDU session of one terminal, and ethernet MAC addresses corresponding to different terminals do not conflict with each other, so that when the bill of the subscriber is generated based on the ethernet MAC address that can uniquely identify the terminal or the PDU session of the terminal, correctness of the generated bill may be ensured.

According to a seventh aspect, an apparatus for determining an ethernet MAC address is provided. The apparatus has a function for implementing any method provided in the first aspect or the second aspect. The function may be implemented by hardware, or may be implemented by hardware executing corresponding software. The hardware or the software includes one or more units corresponding to the function. The apparatus may exist in a product form of a chip.

According to an eighth aspect, an apparatus for determining an ethernet MAC address is provided. The apparatus has a function for implementing any method provided in the third aspect or the fourth aspect. The function may be implemented by hardware, or may be implemented by hardware executing corresponding software. The hardware or the software includes one or more units corresponding to the function. The apparatus may exist in a product form of a chip.

According to a ninth aspect, an apparatus for generating a bill is provided. The apparatus has a function for implementing any method provided in the fifth aspect. The function may be implemented by hardware, or may be implemented by hardware executing corresponding software. The hardware or the software includes one or more units corresponding to the function. The apparatus may exist in a product form of a chip.

According to a tenth aspect, an apparatus for generating a bill is provided. The apparatus has a function for implementing any method provided in the sixth aspect. The function may be implemented by hardware, or may be implemented by hardware executing corresponding software. The hardware or the software includes one or more units corresponding to the function. The apparatus may exist in a product form of a chip.

According to an eleventh aspect, an apparatus for determining an ethernet MAC address is provided. The apparatus includes a memory and a processor. The memory is configured to store a computer executable instruction, and the processor executes the computer executable instruction stored in the memory, so that the apparatus is enabled to implement any method provided in the first aspect or the second aspect. The apparatus may exist in a product form of a chip.

According to a twelfth aspect, an apparatus for determining an ethernet MAC address is provided. The apparatus includes a memory and a processor. The memory is configured to store a computer executable instruction, and the processor executes the computer executable instruction stored in the memory, so that the apparatus is enabled to implement any method provided in the third aspect or the fourth aspect. The apparatus may exist in a product form of a chip.

According to a thirteenth aspect, an apparatus for generating a bill is provided. The apparatus includes a memory and a processor. The memory is configured to store a computer executable instruction, and the processor executes the computer executable instruction stored in the memory, so that the apparatus is enabled to implement any method provided in the fifth aspect. The apparatus may exist in a product form of a chip.

According to a fourteenth aspect, an apparatus for generating a bill is provided. The apparatus includes a memory and a processor. The memory is configured to store a computer executable instruction, and the processor executes the computer executable instruction stored in the memory, so that the apparatus is enabled to implement any method provided in the sixth aspect. The apparatus may exist in a product form of a chip.

According to a fifteenth aspect, a computer-readable storage medium is provided. The computer-readable storage medium includes an instruction, and when the instruction is run on a computer, the computer is enabled to perform any method provided in the first aspect or the second aspect.

According to a sixteenth aspect, a computer-readable storage medium is provided. The computer-readable storage medium includes an instruction, and when the instruction is run on a computer, the computer is enabled to perform any method provided in the third aspect or the fourth aspect.

According to a seventeenth aspect, a computer-readable storage medium is provided. The computer-readable storage medium includes an instruction, and when the instruction is run on a computer, the computer is enabled to perform any method provided in the fifth aspect.

According to an eighteenth aspect, a computer-readable storage medium is provided. The computer-readable storage medium includes an instruction, and when the instruction is run on a computer, the computer is enabled to perform any method provided in the sixth aspect.

According to a nineteenth aspect, a computer program product including an instruction is provided. When the computer program product is run on a computer, the computer is enabled to perform any method provided in the first aspect or the second aspect.

According to a twentieth aspect, a computer program product including an instruction is provided. When the computer program product is run on a computer, the computer is enabled to perform any method provided in the third aspect or the fourth aspect.

According to a twenty-first aspect, a computer program product including an instruction is provided. When the computer program product is run on a computer, the computer is enabled to perform any method provided in the fifth aspect.

According to a twenty-second aspect, a computer program product including an instruction is provided. When the computer program product is run on a computer, the computer is enabled to perform any method provided in the sixth aspect.

For technical effects brought by any design in the seventh aspect to the twenty-second aspect, refer to technical effects brought by different designs in the first aspect to the sixth aspect Details are not described herein again.

### BRIEF DESCRIPTION OF DRAWINGS

FIG. 1 is a schematic diagram of an architecture of a 5G network according to an embodiment of this application;

FIG. 2 is a schematic diagram of an architecture of a protocol stack that supports an ethernet frame according to an embodiment of this application;

FIG. 3 is a schematic diagram of another architecture of a 5G network according to an embodiment of this application;

FIG. 4 is a flowchart of a method for determining an ethernet MAC address according to an embodiment of this application;

FIG. 5 is a schematic diagram of connecting a terminal to a network by using a PDU session according to an embodiment of this application;

FIG. 6 is a schematic structural diagram of a user plane packet according to an embodiment of this application;

FIG. 7 is a schematic structural diagram of a 5G ethernet packet according to an embodiment of this application;

FIG. 8 is a flowchart of another method for determining an ethernet MAC address according to an embodiment of this application;

FIG. 9A and FIG. 9B are flowcharts of another method for determining an ethernet MAC address according to an embodiment of this application;

FIG. 10A to FIG. 10E are flowcharts of another method for determining an ethernet MAC address according to an embodiment of this application;

FIG. 11 is a schematic composition diagram of an apparatus according to an embodiment of this application; and

FIG. 12 is a schematic hardware composition diagram of another apparatus according to an embodiment of this application.

### DESCRIPTION OF EMBODIMENTS

The following describes technical solutions in embodiments of this application with reference to the accompanying drawings in the embodiments of this application. In description of this application, “I” means “or” unless otherwise specified. For example, AB may represent A or B. In this specification, “and/or” describes only an association relationship for describing associated objects and represents that three relationships may exist. For example, A and/or B may represent the following three cases: Only A exists, both A and B exist, and only B exists. In addition, in the descriptions of this application, “a plurality of” means two or more than two.

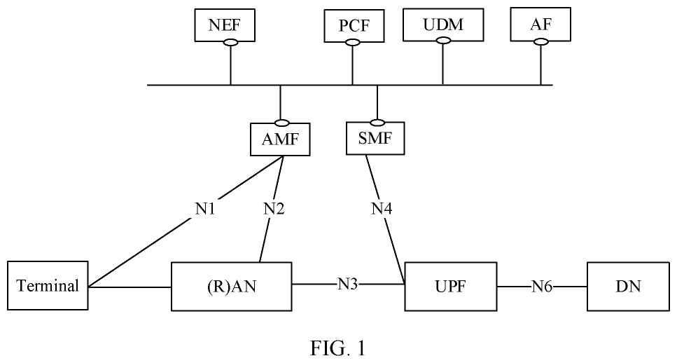

Referring to FIG. 1, in a 5G network architecture, a core network is divided into a control plane (CP) and a UP. The UP includes a user plane function (UPF) network element. The CP include s an access and mobility management function (AMF) network element, a session management function (SMF) network element, a policy control function (PCF) network element, a unified data management (UDM) network element, a network exposure function (NEF) network element, and the like. The 5G network may further include an application function (AF) network element. The SMF controls the UPF by using an N4 interface. The AMF performs information exchange with a (radio) access network ((R)AN) device and a terminal by respectively using an N2 interface and an N1 interface, to complete functions such as registration, session establishment, and mobility management. The (R)AN device performs information exchange with the UPF by using an N3 interface. The UPF performs information exchange with a data network (DN) by using an N6 interface.

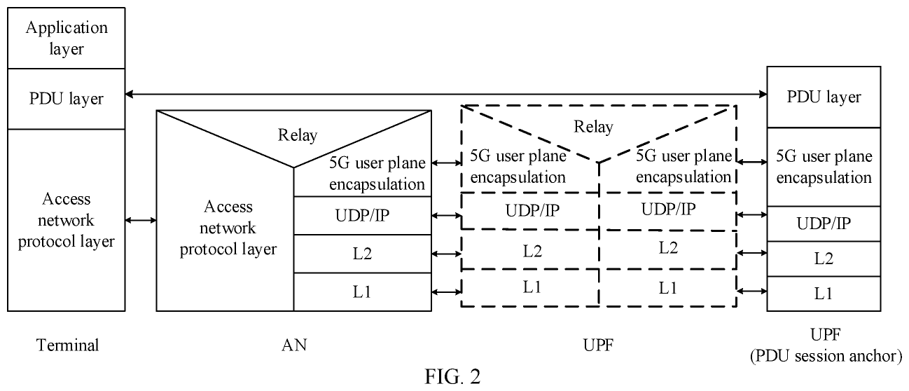

In a 5G wireless communications technology, transmission of an ethernet frame explicitly requires to be supported. In the 5G technical specification, an architecture of a protocol stack that supports an ethernet frame is further provided. For details, refer to FIG. 2. A protocol stack of a terminal includes an application layer, a packet data unit (PDU) layer, and an access network protocol layer from top to bottom. A protocol stack of an access network (AN) for communication with the terminal includes an access network protocol layer. A protocol stack of the AN for communication with a UPF includes a 5G user plane encapsulation layer, a user datagram protocol (UDP) layer/an IP layer, an L2 layer, and an L1 layer from top to bottom. Relay indicates that a user plane packet is mapped, in the uplink, from a 5G AN protocol stack (for example, a packet data convergence protocol (PDCP) layer) to a 5G user plane protocol stack (for example, a general packet radio service tunneling protocol-user plane (GTP-U) layer), and a user plane packet is mapped, in the downlink, from the 5G user plane protocol stack (for example, the GTP-U) to the 5G AN protocol stack (for example, the PDCP). A protocol stack of the UPF for communication with the AN includes a 5G user plane encapsulation layer, a UDP layer/an IP layer, an L2 layer, and an L1 layer from top to bottom. A protocol stack of the UPF for communication with a UPF that serves as a PDU session anchor include s a 5G user plane encapsulation layer, a UDP layer/an IP layer, an L2 layer, and an L1 layer from top to bottom. Relay indicates that a user plane packet is mapped, in the uplink, from a 5G user plane protocol stack (for example, the GTP-U) of an N3 port to a 5G user plane protocol stack (for example, the GTP-U) of an N9 port, and a user plane packet is mapped, in the downlink, from the 5G user plane protocol stack (for example, the GTP-U) of the N9 port to the 5G user plane protocol stack (for example, the GTP-U) of the N3 port. A protocol stack of the UPF that serves as the PDU session anchor includes a PDU layer, a 5G user plane encapsulation layer, a UDP layer/an IP layer, an L2 layer, and an L1 layer from top to bottom.

The PDU layer carries a payload of a PDU session. When a type of the PDU session is an ethernet type, the payload of the PDU session is an ethernet frame.

An embodiment of this application provides a method for determining an ethernet MAC address of a terminal. By detecting whether an ethernet MAC address can uniquely identify the terminal or a PDU session of the terminal within a global network range, a unique ethernet MAC address is allocated to the terminal or the PDU session of the terminal.

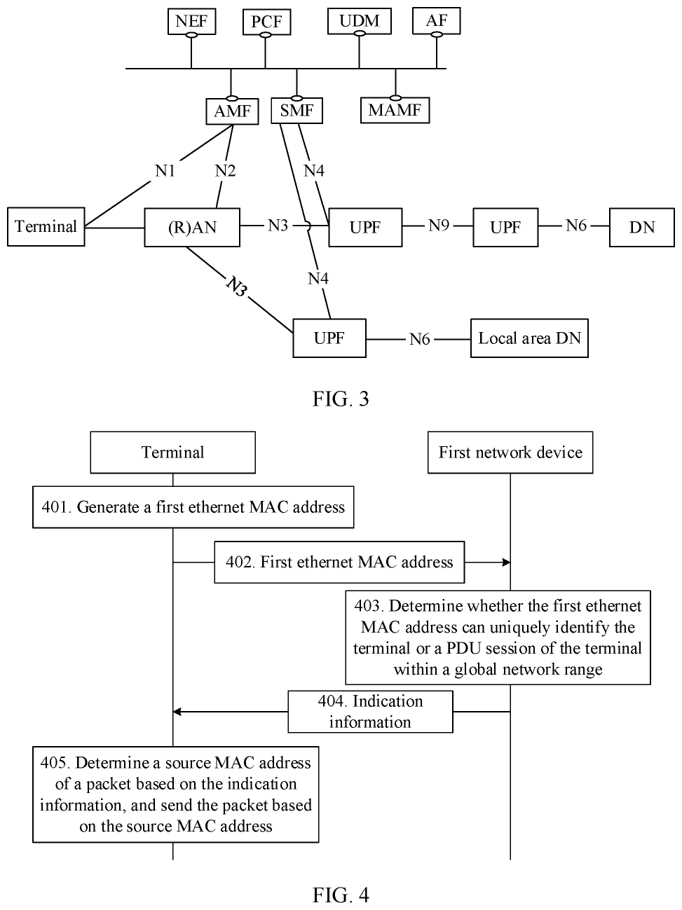

During specific implementation, a device capable of detecting whether an ethernet MAC address can uniquely identify the terminal or the PDU session of the terminal within the global network range may be disposed in a network. For example, referring to FIG. 3, a MAC address management function (MAMF for short) network element may be added to a control plane, and is responsible for registration, allocation, reallocation, conflict check, detection, and recycling of an ethernet MAC address. Functions of the MAMF may alternatively be integrated into an existing network element. For example, the functions of the MAMF may be integrated into an SMF, or the functions of the MAMF may be integrated into an AMF.

An embodiment of this application provides a method for determining an ethernet MAC address. As shown in FIG. 4, the method includes the following operations.

401. A terminal generates a first ethernet MAC address.

For example, apiece of software for generating an ethernet MAC address may be installed on the terminal or a program for generating an ethernet MAC address may be embedded in the terminal, and the terminal may generate an ethernet MAC address based on the software or the program.

402. The terminal sends the first ethernet MAC address to a first network device. Correspondingly, the first network device receives the first ethernet MAC address from the terminal.

The first network device may be an MAMF network element, or an SMF in which a function of the MAMF is integrated.

The terminal may add the first ethernet MAC address to a message sent in a PDU session establishment process. For example, if the first network device is the MAMF network element, the first ethernet MAC address may be included in a PDU session establishment request sent by the terminal to an AMF, the AMF sends the PDU session establishment request to an SMF, and the SMF obtains the first ethernet MAC address and sends the first ethernet MAC address to the MAMF. If the first network device is the SMF, the first ethernet MAC address may be included in a PDU session establishment request sent by the terminal to an AMF, the AMF sends the PDU session establishment request to an SMF, and the SMF obtains the first ethernet MAC address.

403. The first network device determines whether the first ethernet MAC address can uniquely identify the terminal or a PDU session of the terminal within a global network range.

For example, an ethernet MAC address database may be locally maintained in the first network device. The ethernet MAC address database may include an allocated ethernet MAC address and an unallocated ethernet MAC address. The first network device may determine, based on whether the first ethernet MAC address is allocated, whether the first ethernet MAC address can uniquely identify the terminal or the PDU session of the terminal within the global network range. For example, if the first ethernet MAC address is allocated, the first ethernet MAC address cannot uniquely identify the terminal or the PDU session of the terminal within the global network range. If the first ethernet MAC address is not allocated, the first ethernet MAC address can uniquely identify the terminal or the PDU session of the terminal within the global network range.

It should be noted that the ethernet MAC address database may alternatively be maintained in another network element, and the first network device may obtain ethernet MAC address data by interacting with the network element that maintains the ethernet MAC address database, to complete determining of the first ethernet MAC address.

The global network may be selected based on an actual application scenario. For example, the global network may be the entire internet, and may specifically be an operator network, and the operator network may specifically be a provincial network, a municipal network, or the like in the operator network.

404. The first network device sends indication information to the terminal based on a determining result, and the terminal receives the indication information from the first network device.

The indication information is used to determine a source MAC address of a packet sent by the terminal, and the source MAC address of the packet sent by the terminal is an ethernet MAC address that can uniquely identify the terminal or the PDU session of the terminal within the global network range.

In one embodiment, a type of the PDU session of the terminal may be an ethernet type.

405. The terminal determines the source MAC address of the packet based on the indication information, and sends the packet based on the source MAC address.

Specifically, the terminal may determine, as the source MAC address of the packet, an ethernet MAC address that is directly or indirectly indicated in the indication information and that can uniquely identify the terminal or the PDU session of the terminal within the global network range.

According to the method provided in this embodiment of this application, the first network device determines the first ethernet MAC address generated by the terminal and sends the indication information to the terminal, and the terminal determines the source MAC address of the packet based on the indication information. Because the source MAC address is an ethernet MAC address that can uniquely identify the terminal or the PDU session of the terminal within the global network range, one terminal can be uniquely determined based on the ethernet MAC address, and ethernet MAC addresses corresponding to different terminals do not conflict with each other. Therefore, when packet forwarding is performed based on the ethernet MAC address that can uniquely identify the terminal or the PDU session of the terminal, correctness of packet forwarding can be ensured.

If the first ethernet MAC address cannot uniquely identify the terminal or the PDU session of the terminal within the global network range, for specific content of the indication information, refer to Case 1 or Case 2.

Case 1. The indication information indicates that the first ethernet MAC address cannot uniquely identify the terminal or the PDU session of the terminal within the global network range.

In one embodiment, the first network device may send a reject message to the terminal, to indicate that the first ethernet MAC address cannot uniquely identify the terminal or the PDU session of the terminal within the global network range. After receiving the reject message, the terminal removes the locally generated first ethernet MAC address. The reject message may further include reject cause information, and a reject cause may be an ethernet MAC address conflict.

In this case, after receiving the indication information, the terminal may regenerate an ethernet MAC address, and send the ethernet MAC address to the first network device. The first network device continues to determine whether the ethernet MAC address regenerated by the terminal can uniquely identify the terminal or the PDU session of the terminal within the global network range, until an ethernet MAC address generated by the terminal can uniquely identify the terminal or the PDU session of the terminal within the global network range.

In one embodiment, before operation 401, the method may further include: generating, by the terminal, a fifth ethernet MAC address, and sending the fifth ethernet MAC address to the first network device; and receiving, by the terminal from the first network device, information used to indicate that the fifth ethernet MAC address cannot uniquely identify the terminal or the PDU session of the terminal within the global network range.

After receiving the fifth ethernet MAC address, if the first network device determines that the fifth ethernet MAC address cannot uniquely identify the terminal or the PDU session of the terminal within the global network range, the first network device sends, to the terminal, the information indicating that the fifth ethernet MAC address cannot uniquely identify the terminal or the PDU session of the terminal within the global network range. After receiving the information, the terminal regenerates a first ethernet MAC address.

Case 2. The indication information includes a second ethernet MAC address.

The second ethernet MAC address may be an ethernet MAC address allocated by the first network device to the terminal, and the second ethernet MAC address can uniquely identify the terminal or the PDU session of the terminal within the global network range. In this case, after receiving the indication information, the terminal may determine that the source MAC address of the packet of the terminal is the second ethernet MAC address.

In one embodiment, a second network device may send an allocation request to the first network device, and the first network device allocates the second ethernet MAC address to the terminal based on the allocation request. In this case, the first network device may be an MAMF network element, and the second network device may be an SMF.

The source MAC address of the packet of the terminal is the second ethernet MAC address, and after receiving the uplink packet sent by the terminal, a UPF forwards a received downlink packet whose destination MAC address is the second ethernet MAC address to the terminal. Because the second ethernet MAC address uniquely identifies the terminal or a PDU session of the terminal, a packet forwarding error may be avoid.

When the terminal establishes a plurality of PDU sessions, one PDU session may correspond to one ethernet MAC address.

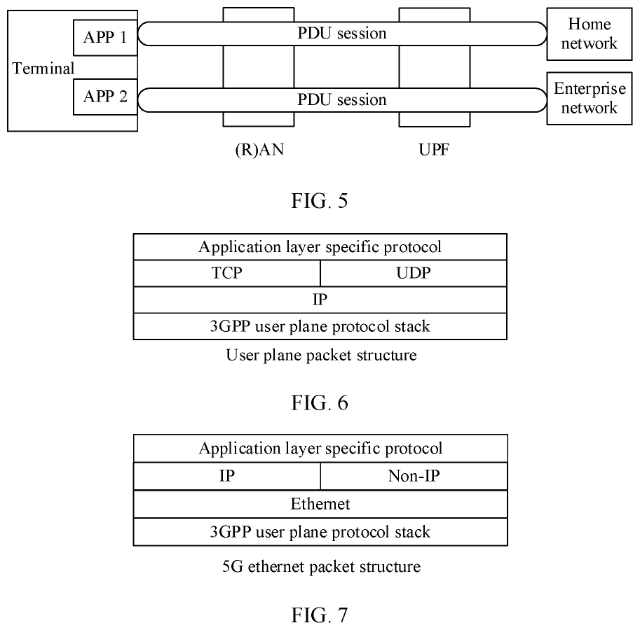

For example, after obtaining the second ethernet MAC address, the terminal may bind the second ethernet MAC address to the terminal. In this case, a network device that receives the packet whose destination MAC address is the second ethernet MAC address may forward the packet to the terminal based on the second ethernet MAC address in a packet header of the packet. The terminal may alternatively bind the second ethernet MAC address to a first PDU session of the terminal. When the terminal accesses a DN network by using the first PDU session, an uplink ethernet frame uses the second ethernet MAC address as a source MAC address. In this case, the network device that receives the packet whose destination MAC address is the second ethernet MAC address may forward, based on the second ethernet MAC address in the packet header of the packet, the packet to an application connected to the first PDU session of the terminal. Referring to FIG. 5, two APPs (Application) in a terminal are connected to different networks by respectively using two PDU sessions, for example, the two different networks may be a home network and an enterprise network. In this case, if one ethernet MAC address is bound to one PDU session, a UPF may forward, based on an ethernet MAC address corresponding to each PDU session, a packet to an APP connected to the PDU session.

In one embodiment, the method may further include: setting, by the first network device, that the second ethernet MAC address in the ethernet MAC address database cannot be allocated. For example, the first network device may delete the second ethernet MAC address from unallocated ethernet MAC addresses, and add the second ethernet MAC address to allocated ethernet MAC addresses, or the first network device may identify the second ethernet MAC address from an allocatable state to an unallocatable state.

In one embodiment, the method may further include: sending, by the first network device, the second ethernet MAC address to the second network device. Correspondingly, the second network device receives the second ethernet MAC address from the first network device, and the second network device establishes a correspondence between the second ethernet MAC address and an identifier of a subscriber corresponding to the terminal, and sends the correspondence to a third network device. The third network device receives, from the second network device, the correspondence between the second ethernet MAC address and the identifier of the subscriber corresponding to the terminal, and generates a bill of the subscriber based on the correspondence. In this case, the first network device may be an MAMF network element, the second network device may be an SMF, and the third network device may be a UPF.

When the first network device is the MAMF network element, the first network device cannot determine the identifier of the subscriber, and cannot establish the correspondence between the second ethernet MAC address and the identifier of the subscriber corresponding to the terminal. In this case, the first network device may send the second ethernet MAC address to the SMF, and the SMF establishes the correspondence between the second ethernet MAC address and the identifier of the subscriber corresponding to the terminal.

The identifier of the subscriber may be a 5G subscription permanent identifier (SUPI), an international mobile subscriber identity (IMSI), a temporary mobile subscriber identity (TMSI), or the like.

In one embodiment, the method may further include: establishing, by the first network device, a correspondence between the second ethernet MAC address and an identifier of a subscriber corresponding to the terminal, and sends the correspondence to a third network device. The third network device receives, from the first network device, the correspondence between the second ethernet MAC address and the identifier of the subscriber corresponding to the terminal, and generates a bill of the subscriber based on the correspondence. In this case, the first network device may be an SMF, and the third network device is a UPF.

When the first network device is the SMF, because the SMF can sense the identifier of the subscriber corresponding to the terminal and the first network device can determine the identifier of the subscriber corresponding to the terminal, the first network device may establish the correspondence between the second ethernet MAC address and the identifier of the subscriber corresponding to the terminal.

It should be noted that one 3GPP user plane protocol stack in this embodiment of this application corresponds to one terminal. When a device has a plurality of 3GPP user plane protocol stacks, the device may be considered as a plurality of terminals. For example, a dual-card mobile phone has two 3GPP user plane protocol stacks, and the dual-card mobile phone may be considered as two terminals.

Referring to FIG. 6, a 3GPP user plane protocol stack carries IP data, and the IP data includes an IP header, transmission control protocol (TCP) data, and UDP data. In the prior art, because IP addresses are mapped to terminals one by one, a bill of a subscriber may be generated by collecting statistics on traffic of an IP packet. In an ethernet scenario, an IP address of a terminal may be private and variable, and is not globally unique, so that IP addresses of a plurality of terminals may conflict with each other, and a terminal to which an IP packet belongs cannot be known. Therefore, in the ethernet scenario, the bill of the subscriber cannot be correctly generated by collecting statistics on the traffic of the IP packet. However, a hardware MAC address of the terminal is beyond a control range of the 3GPP network, and a correspondence between the hardware MAC address of the terminal and the user cannot be determined. In addition, hard MAC addresses of terminals may conflict with each other. Therefore, the bill of the subscriber cannot be correctly generated based on the hardware MAC address of the terminal. In addition, if the ethernet carries a non-IP packet and the packet does not have an IP address, a user to which the packet belongs cannot be determined as well.

According to the method provided in this embodiment of this application, one ethernet MAC address corresponds only to one terminal or one PDU session of one terminal, and ethernet MAC addresses corresponding to different terminals do not conflict with each other. Therefore, when the bill of the subscriber is generated based on the ethernet MAC address that can uniquely identify the terminal or the PDU session of the terminal, correctness of the generated bill may be ensured. For example, referring to FIG. 7, in a 5G ethernet packet structure, a 3GPP user plane protocol stack carries an ethernet frame, and the ethernet frame includes an ethernet frame header, an IP header, and non-IP header. The IP header may carry conventional TCP and UDP data, and the non-IP header may carry a special application, for example, an industrial control application. The UPF may generate the bill of the subscriber by collecting statistics on the ethernet frame.

If the first ethernet MAC address can uniquely identify the terminal or the PDU session of the terminal within the global network range, for specific content of the indication information, refer to at least one of Case 3 and Case 4.

Case 3. The indication information indicates that the first ethernet MAC address can uniquely identify the terminal or the PDU session of the terminal within the global network range.

Case 4. The indication information includes the first ethernet MAC address.

In case 3 and case 4, the terminal may determine that the source MAC address of the packet of the terminal is the first ethernet MAC address.

The source MAC address of the packet of the terminal is the first ethernet MAC address, and after receiving the packet sent by the terminal, the UPF forwards a received packet whose destination MAC address is the first ethernet MAC address to the terminal. Because the first ethernet MAC address uniquely identifies the terminal or a PDU session of terminal, a packet forwarding error may be avoided.

For example, after obtaining the first ethernet MAC address, the terminal may bind the first ethernet MAC address to the terminal or a first PDU session of the terminal. For specific descriptions, refer to the foregoing example descriptions. Details are not described herein again.

In one embodiment, the method may further include: setting, by the first network device, that the first ethernet MAC address in the ethernet MAC address database cannot be allocated. For example, the first network device may delete the first ethernet MAC address from unallocated ethernet MAC addresses, and add the first ethernet MAC address to allocated ethernet MAC addresses, or the first network device may set the first ethernet MAC address from an allocatable state to an unallocatable state.

In one embodiment, the method may further include: sending, by the first network device, the first ethernet MAC address to the second network device, receiving, by the second network device, the first ethernet MAC address from the first network device, and establishing, by the second network device, a correspondence between the first ethernet MAC address and an identifier of a subscriber corresponding to the terminal; and sending, by the second network device, the correspondence to a third network device, receiving, by the third network device from the second network device, the correspondence between the first ethernet MAC address and the identifier of the subscriber corresponding to the terminal, and generating, by the third network device, a bill of the subscriber based on the correspondence. In this case, the first network device may be an MAMF network element, the second network device may be an SMF, and the third network device may be a UPF.

When the first network device is the MAMF network element, the first network device cannot determine the identifier of the subscriber corresponding to the terminal, and cannot establish the correspondence between the first ethernet MAC address and the identifier of the subscriber corresponding to the terminal. In this case, the first network device may send the first ethernet MAC address to the SMF, and the SMF establishes the correspondence between the first ethernet MAC address and the identifier of the subscriber corresponding to the terminal.

In one embodiment, the method may further include: establishing, by the first network device, a correspondence between the first ethernet MAC address and an identifier of a subscriber corresponding to the terminal; and sending, by the first network device, the correspondence to a third network device, receiving, by the third network device from the first network device, the correspondence between the first ethernet MAC address and the identifier of the subscriber corresponding to the terminal, and generating, by the third network device, a bill of the subscriber based on the correspondence. In this case, the first network device may be an SMF, and the third network device is a UPF.

When the first network device is the SMF, because the SMF can sense the identifier of the subscriber corresponding to the terminal and the first network device can determine the identifier of the subscriber corresponding to the terminal, the first network device may establish the correspondence between the first ethernet MAC address and the identifier of the subscriber corresponding to the terminal.

The bill of the subscriber can be correctly generated based on the first ethernet MAC address. For specific analysis, refer to the foregoing related example descriptions of the second ethernet MAC address, and details are not described herein again.

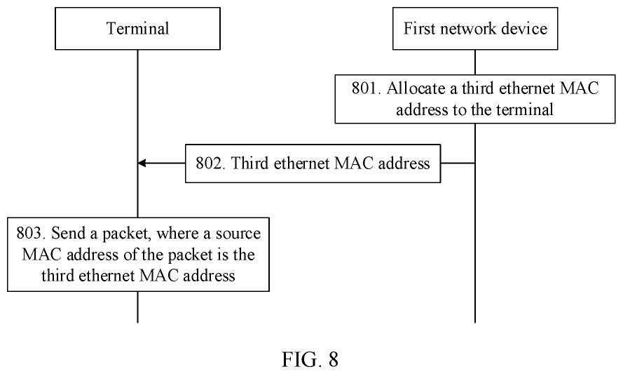

An embodiment of this application further provides a method for determining an ethernet MAC address. For explanations of related content in the foregoing method, refer to the foregoing description. As shown in FIG. 8, the method may include the following operations.

801. A first network device allocates a third ethernet MAC address to a terminal.

The third ethernet MAC address can uniquely identify the terminal or a PDU session of the terminal within a global network range. A type of the PDU session of the terminal may be an ethernet type.

For example, an ethernet MAC address database may be locally maintained in the first network device. The ethernet MAC address database may include an allocated ethernet MAC address and an unallocated ethernet MAC address. The first network device allocates the third ethernet MAC address based on the ethernet MAC address database, and the third ethernet MAC address may be one of unallocated ethernet MAC addresses in the ethernet MAC address database. Certainly, the ethernet MAC address database may alternatively be maintained in another network entity. For example, the ethernet MAC address database may be maintained in a UDM. The first network device requests unallocated ethernet MAC addresses from the UDM, and selects the third ethernet MAC address from the unallocated ethernet MAC addresses.

In one embodiment, before operation 801, the method may further include: sending, by a second network device, an allocation request to the first network device, and receiving, by the first network device, the allocation request from the second network device. In specific implementation, operation 801 may include: allocating, by the first network device, the third ethernet MAC address to the terminal based on the allocation request. In this case, the first network device may be an MAMF network element, and the second network device may be an SMF.

In one embodiment, before operation 801, the method may further include: receiving, by the first network device, a fourth ethernet MAC address from the terminal; and determining, by the first network device, that the fourth ethernet MAC address cannot uniquely identify the terminal or the PDU session of the terminal within the global network range.

The fourth ethernet MAC address is an ethernet MAC address generated by the terminal. The first network device may allocate the third ethernet MAC address to the terminal when determining that the ethernet MAC address generated by the terminal cannot uniquely identify the terminal or the PDU session of the terminal within the global network range, or may directly allocate the third ethernet MAC address to the terminal.

802. The first network device sends the third ethernet MAC address to the terminal. Correspondingly, the terminal receives the third ethernet MAC address from the first network device.

When the first network device is the MAMF network element, the first network device may send the third ethernet MAC address to the SMF, and the SMF sends the third ethernet MAC address to the terminal by using NAS signaling.

803. The terminal sends a packet, where a source MAC address of the packet is the third ethernet MAC address.

After operation 803, when receiving the packet sent by the terminal, a UPF determines the third ethernet MAC address by parsing the packet, to send, to the terminal, a packet whose destination MAC address is the third ethernet MAC address when receiving the packet.

According to the method provided in this embodiment of this application, the first network device allocates the third ethernet MAC address to the terminal, and the terminal determines that the third ethernet MAC address is the source MAC address of the packet sent by the terminal. Because the third ethernet MAC address is an ethernet MAC address that can uniquely identify the terminal or the PDU session of the terminal within the global network range, one terminal can be uniquely determined based on the third ethernet MAC address, and ethernet MAC addresses corresponding to different terminals do not conflict with each other. Therefore, when packet forwarding is performed based on the third ethernet MAC address, correctness of packet forwarding can be ensured.

In one embodiment, the method may further include: setting, by the first network device, that the third ethernet MAC address in an ethernet MAC address database cannot be allocated. For example, the first network device may delete the third ethernet MAC address from unallocated ethernet MAC addresses, and add the third ethernet MAC address to allocated ethernet MAC addresses, or the first network device may set the third ethernet MAC address from an allocatable state to an unallocatable state.

In one embodiment, the method may further include: sending, by the first network device, the third ethernet MAC address to the second network device, receiving, by the second network device, the third ethernet MAC address from the first network device, and establishing, by the second network device, a correspondence between the third ethernet MAC address and an identifier of a subscriber corresponding to the terminal; and sending, by the second network device, the correspondence to a third network device, receiving, by the third network device from the second network device, the correspondence between the third ethernet MAC address and the identifier of the subscriber corresponding to the terminal, and generating, by the third network device, a bill of the subscriber based on the correspondence. In this case, the first network device may be an MAMF network element, the second network device may be an SMF, and the third network device may be a UPF.

When the first network device is the MAMF network element, the first network device cannot determine the identifier of the subscriber corresponding to the terminal, and cannot establish the correspondence between the third ethernet MAC address and the identifier of the subscriber corresponding to the terminal. In this case, the first network device may send the third ethernet MAC address to the SMF, and the SMF establishes the correspondence between the third ethernet MAC address and the identifier of the subscriber corresponding to the terminal.

In one embodiment, the method may further include: establishing, by the first network device, a correspondence between the third ethernet MAC address and an identifier of a subscriber corresponding to the terminal; and sending, by the first network device, the correspondence to a third network device, receiving, by the third network device from the first network device, the correspondence between the third ethernet MAC address and the identifier of the subscriber corresponding to the terminal, and generating, by the third network device, a bill of the subscriber based on the correspondence. In this case, the first network device may be an SMF, and the third network device is a UPF.

When the first network device is an SMF, because the SMF can sense the identifier of the subscriber corresponding to the terminal and the first network device can determine the identifier of the subscriber corresponding to the terminal, the first network device may establish the correspondence between the third ethernet MAC address and the identifier of the subscriber corresponding to the terminal.

The bill of the subscriber can be correctly generated based on the third ethernet MAC address. For specific analysis, refer to the foregoing related example descriptions of the second ethernet MAC address, and details are not described herein again.

The method provided in this embodiment of this application may be implemented in a process of establishing a PDU session of an ethernet type, and may specifically be implemented by using methods described in the following two embodiments. In the four embodiments, the method provided in this embodiment of this application is described by using an example in which the MAMF is an independent network element. When functions of the MAMF are integrated into an SMF (or an AMF), correspondingly, an operation of the MAMF may be performed by the SMF (or the AMF), and interaction between the MAMF and the SMF (or interaction between the MAMF and the AMF) may be omitted. Details are not described again.

### Embodiment 1

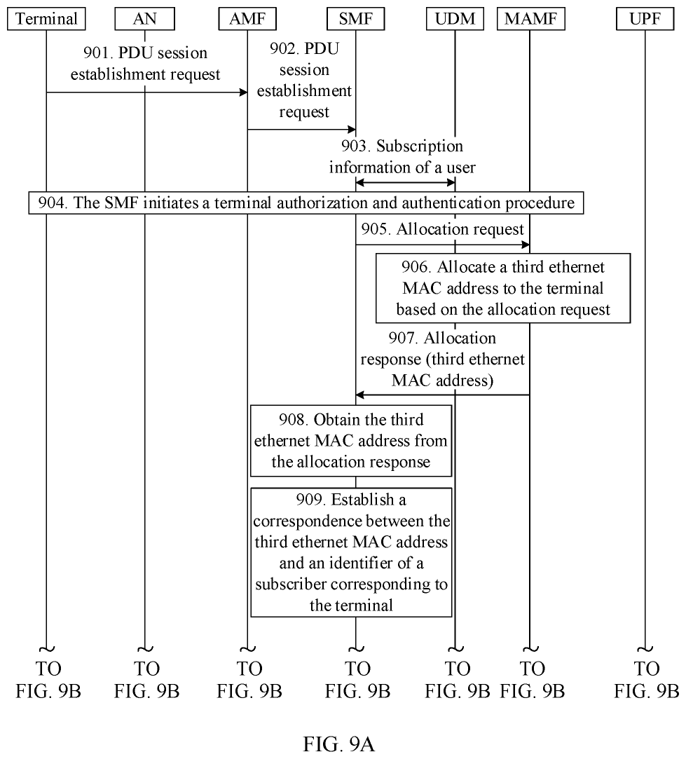

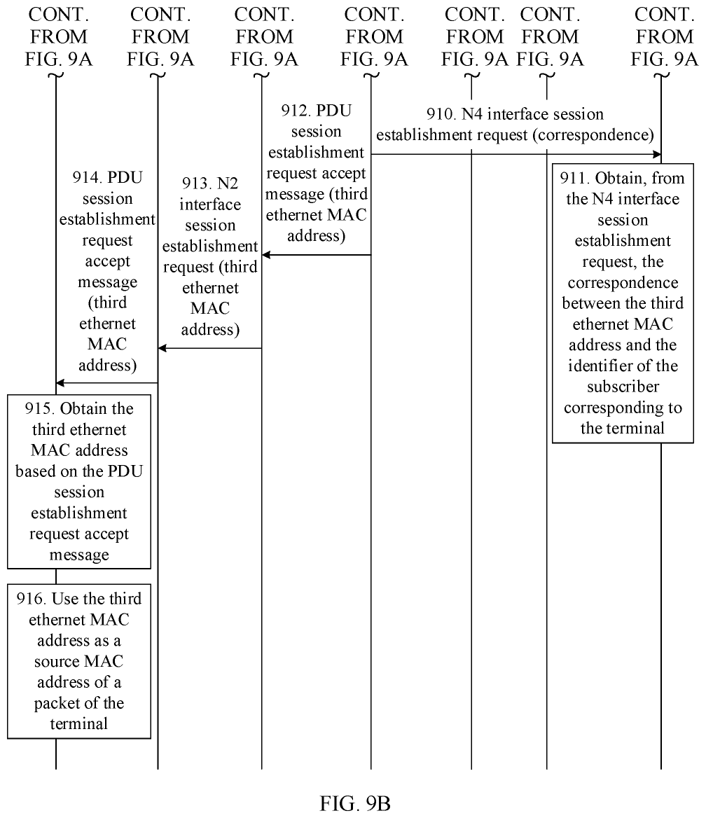

In this embodiment, the MAMF generates a third ethernet MAC address. Referring to FIG. 9A and FIG. 9B, the method may include the following operations.

901. A terminal sends a PDU session establishment request to an AMF. Correspondingly, the AMF receives the PDU session establishment request from the terminal.

A session that the terminal requests to establish may be a PDU session of an ethernet type.

902. The AMF sends the PDU session establishment request to an SMF. Correspondingly, the SMF receives the PDU session establishment request from the AMF.

The SMF may be selected by the AMF.

903. The SMF requests subscription information of a user from a UDM.

904. The SMF initiates a terminal authorization and authentication procedure.

After operation 904 is performed, if the terminal has been authenticated, the following operations are performed.

905. The SMF sends an allocation request to the MAMF. Correspondingly, the MAMF receives the allocation request from the SMF.

The allocation request is used to request the MAMF to allocate an ethernet MAC address to the terminal.

Before operation 905, the SMF may further determine that the PDU session needing to be established by the terminal is of an ethernet type.

906. The MAMF allocates a third ethernet MAC address to the terminal based on the allocation request, where the third ethernet MAC address can uniquely identify the terminal or a PDU session of the terminal within a global network range.

For a method for allocating an ethernet MAC address, refer to the foregoing related descriptions.

After operation 906, the MAMF may update an ethernet MAC address database.

907. The MAMF sends an allocation response to the SMF. Correspondingly, the SMF receives the allocation response from the MAMF.

The allocation response includes the third ethernet MAC address allocated by the MAMF to the terminal.

908. The SMF obtains the third ethernet MAC address from the allocation response.

909. The SMF establishes a correspondence between the third ethernet MAC address and an identifier of a subscriber corresponding to the terminal.

910. The SMF sends an N4 interface session establishment request to a UPF. Correspondingly, the UPF receives the N4 interface session establishment request from the SMF.

The UPF may be a UPF selected by the SMF to serve the terminal, and the N4 interface session establishment request includes the correspondence between the third ethernet MAC address and the identifier of the subscriber corresponding to the terminal.

After operation 910, the UPF may feed back an N4 interface session establishment response to the SMF.

911. The UPF obtains, from the N4 interface session establishment request, the correspondence between the third ethernet MAC address and the identifier of the subscriber corresponding to the terminal.

After obtaining the correspondence between the third ethernet MAC address and the identifier of the subscriber corresponding to the terminal, the UPF may generate a bill of the subscriber based on the correspondence.

912. The SMF sends a PDU session establishment request accept message to the AMF. Correspondingly, the AMF receives the PDU session establishment request accept message from the SMF.

The PDU session establishment request accept message carries the third ethernet MAC address.

913. The AMF sends an N2 interface session establishment request to an AN. Correspondingly, the AN receives the N2 interface session establishment request from the AMF.

The N2 interface session establishment request carries the third ethernet MAC address, and the N2 interface session establishment request may be a NAS message.

914. The AN sends the PDU session establishment request accept message to the terminal. Correspondingly, the terminal receives the PDU session establishment request accept message from the AN.

915. The terminal obtains the third ethernet MAC address based on the PDU session establishment request accept message.

916. The terminal uses the third ethernet MAC address as a source MAC address of a packet of the terminal.

### Embodiment 2

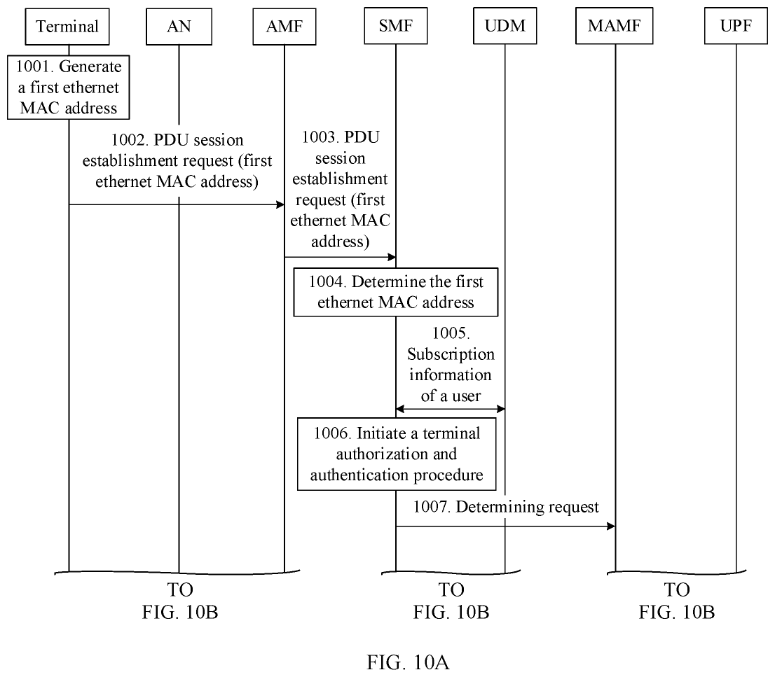

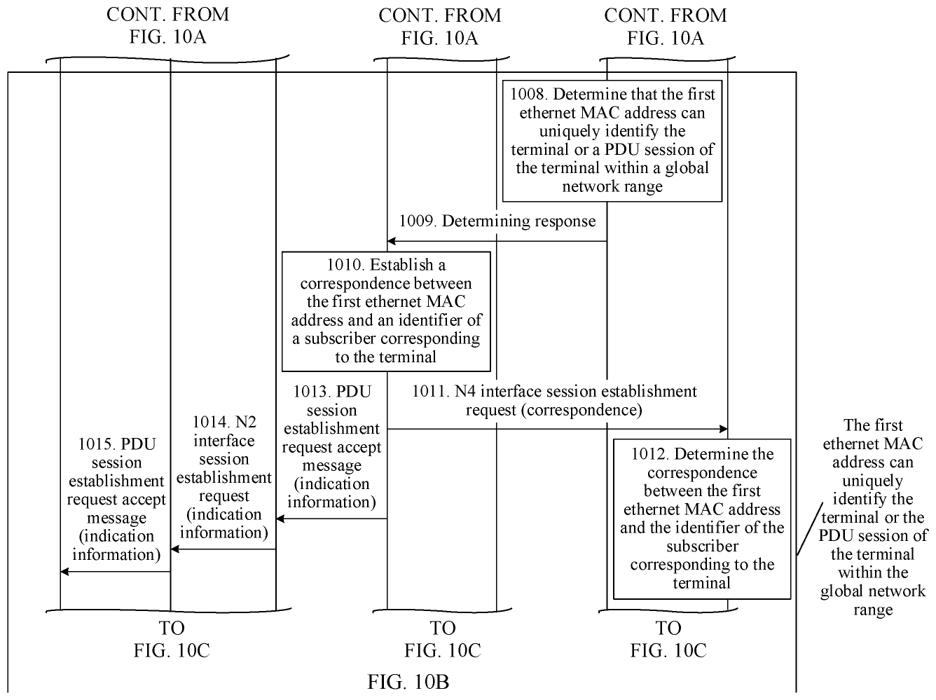

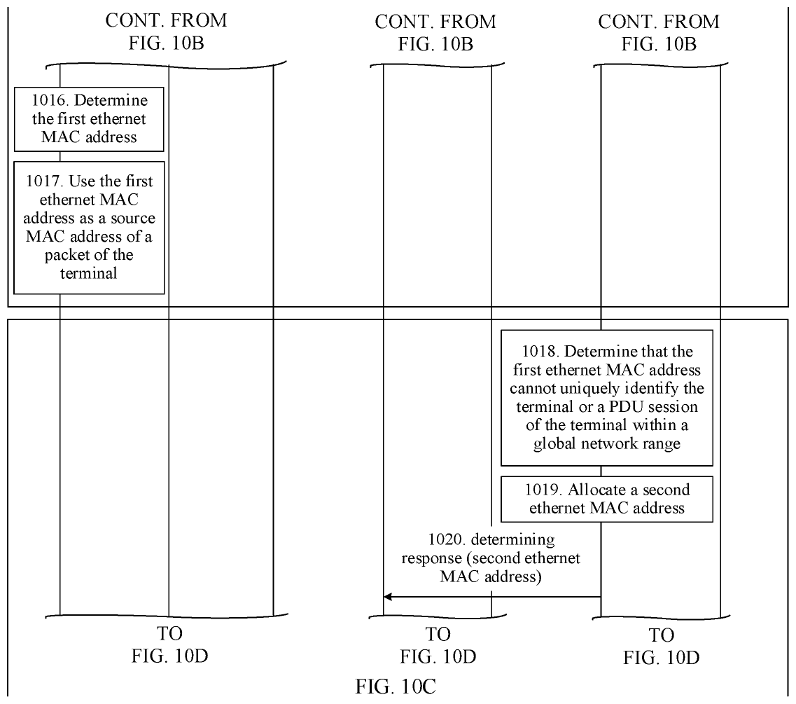

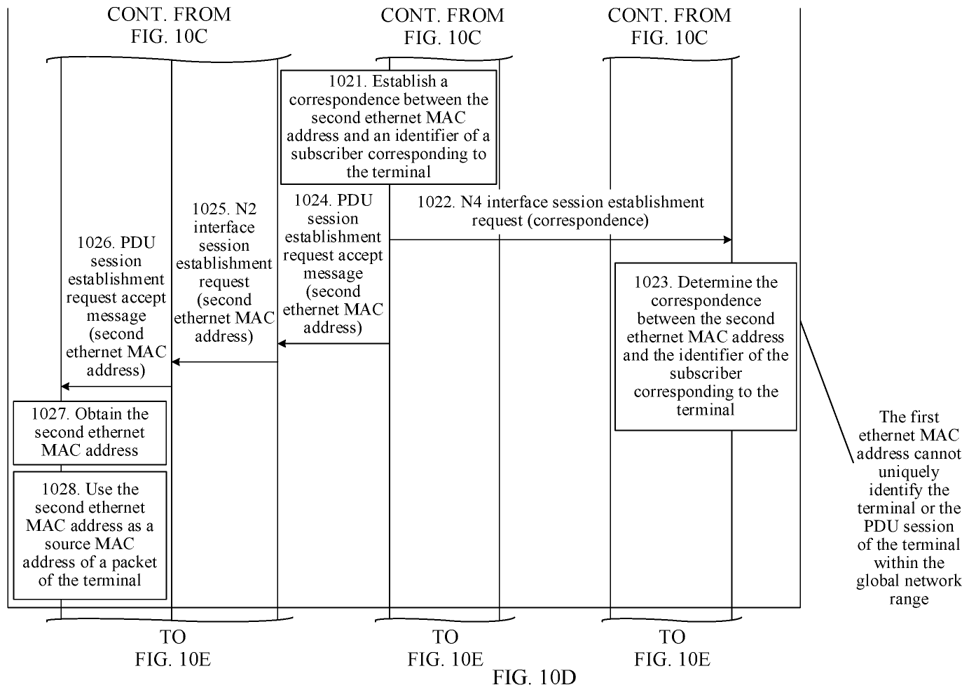

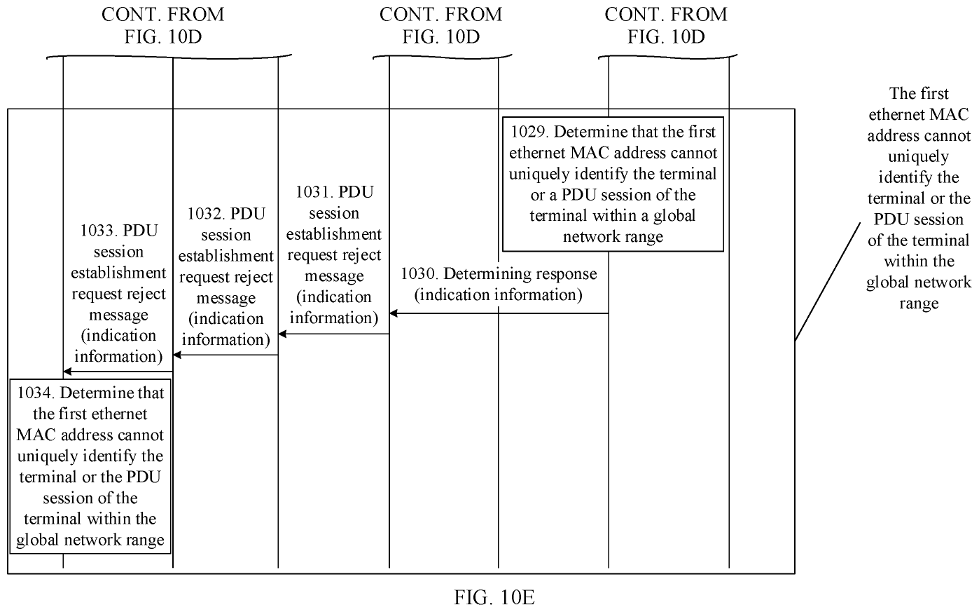

In this embodiment, a terminal generates a first ethernet MAC address. Referring to FIG. 10A to FIG. 10E, the method may include the following operations.

1001. A terminal generates a first ethernet MAC address.

1002. The terminal sends a PDU session establishment request to an AMF. Correspondingly, the AMF receives the PDU session establishment request from the terminal.

The PDU session establishment request includes the first ethernet MAC address, and a PDU session that the terminal requests to establish may be a PDU session of an ethernet type.

1003. The AMF sends the PDU session establishment request to an SMF. Correspondingly, the SMF receives the PDU session establishment request from the AMF.

The SMF may be selected by the AMF.

1004. The SMF determines the first ethernet MAC address based on the PDU session establishment request.

1005. The SMF requests subscription information of a user from a UDM.

1006. The SMF initiates a terminal authorization and authentication procedure.

After operation 1006 is performed, if the terminal has been authenticated, the following operations are performed.

1007. The SMF sends a determining request to the MAMF. Correspondingly, the MAMF receives the determining request from the SMF.

The determining request may include the first ethernet MAC address. The determining request is used to request the MAMF to determine whether the first ethernet MAC address can uniquely identify the terminal or a PDU session of the terminal within a global network range.

Before operation 1007, the SMF may further determine that the PDU session needing to be established by the terminal is of an ethernet type.

If the first ethernet MAC address can uniquely identify the terminal or the PDU session of the terminal within the global network range, operations 1008 to 1017 are performed. If the first ethernet MAC address cannot uniquely identify the terminal or the PDU session of the terminal within the global network range, operations 1018 to 1028 are performed in one case, and operations 1029 to 1034 are performed in another case.

1008. The MAMF determines that the first ethernet MAC address can uniquely identify the terminal or the PDU session of the terminal within the global network range.

1009. The MAMF sends a determining response to the SMF. Correspondingly, the SMF receives the determining response from the MAMF.

The determining response includes indication information, and the indication information includes the first ethernet MAC address or the indication information is used to indicate that the first ethernet MAC address can uniquely identify the terminal or the PDU session of the terminal within the global network range.

1010. The SMF establishes a correspondence between the first ethernet MAC address and an identifier of a subscriber corresponding to the terminal.

1011. The SMF sends an N4 interface session establishment request to a UPF. Correspondingly, the UPF receives the N4 interface session establishment request from the SMF.

The UPF may be a UPF selected by the SMF to serve the terminal, and the N4 interface session establishment request includes the correspondence between the first ethernet MAC address and the identifier of the subscriber corresponding to the terminal.

After operation 1011, the UPF may feed back an N4 interface session establishment response to the SMF.

1012. The UPF determines, based on the N4 interface session establishment request, the correspondence between the first ethernet MAC address and the identifier of the subscriber corresponding to the terminal.

After determining the correspondence between the first ethernet MAC address and the identifier of the subscriber corresponding to the terminal, the UPF may generate a bill of the subscriber based on the correspondence.

1013. The SMF sends a PDU session establishment request accept message to the AMF. Correspondingly, the AMF receives the PDU session establishment request accept message from the SMF.

The PDU session establishment request accept message carries indication information.

1014. The AMF sends an N2 interface session establishment request to an AN. Correspondingly, the AN receives the N2 interface session establishment request from the AMF.

The N2 interface session establishment request carries the indication information, and the N2 interface session establishment request may be a NAS message.

1015. The AN sends the PDU session establishment request accept message to the terminal. Correspondingly, the terminal receives the PDU session establishment request accept message from the AN.

The PDU session establishment request accept message carries the indication information.

1016. The terminal determines the first ethernet MAC address based on the PDU session establishment request accept message.

In specific implementation of operation 1016, if the indication information includes the first ethernet MAC address, the terminal directly determines the first ethernet MAC address in the indication information. If the indication information is used to indicate that the first ethernet MAC address can uniquely identify the terminal or the PDU session of the terminal within the global network range, the terminal may determine the first ethernet MAC address based on the indication information.

1017. The terminal uses the first ethernet MAC address as a source MAC address of a packet of the terminal.

1018. The MAMF determines that the first ethernet MAC address cannot uniquely identify the terminal or the PDU session of the terminal within the global network range.

1019. The MAMF allocates a second ethernet MAC address to the terminal, where the second ethernet MAC address can uniquely identify the terminal or the PDU session of the terminal within the global network range.

For a method for allocating an ethernet MAC address, refer to the foregoing related descriptions.

After operation 1019, the MAMF may update an ethernet MAC address database.

1020. The MAMF sends a determining response to the SMF, where the determining response includes the second ethernet MAC address, and the SMF receives the determining response from the MAMF.

1021. The SMF establishes a correspondence between the second ethernet MAC address and an identifier of a subscriber corresponding to the terminal.

1022. The SMF sends an N4 interface session establishment request to a UPF. Correspondingly, the UPF receives the N4 interface session establishment request from the SMF.

The UPF may be a UPF selected by the SMF to serve the terminal, and the N4 interface session establishment request includes the correspondence between the second ethernet MAC address and the identifier of the subscriber corresponding to the terminal.

After operation 1022, the UPF may feed back an N4 interface session establishment response to the SMF.

1023. The UPF determines, based on the N4 interface session establishment request, the correspondence between the second ethernet MAC address and the identifier of the subscriber corresponding to the terminal.

After determining the correspondence between the second ethernet MAC address and the identifier of the subscriber corresponding to the terminal, the UPF may generate a bill of the subscriber based on the correspondence.

1024. The SMF sends a PDU session establishment request accept message to the AMF. Correspondingly, the AMF receives the PDU session establishment request accept message from the SMF.

The PDU session establishment request accept message carries the second ethernet MAC address.

1025. The AMF sends an N2 interface session establishment request to an AN. Correspondingly, the AN receives the N2 interface session establishment request from the AMF.

The N2 interface session establishment request carries the second ethernet MAC address, and the N2 interface session establishment request may be a NAS message.

1026. The AN sends a PDU session establishment request accept message to the terminal. Correspondingly, the terminal receives the PDU session establishment request accept message from the AN.

The PDU session establishment request accept message carries the second ethernet MAC address.

1027. The terminal obtains the second ethernet MAC address based on the PDU session establishment request accept message.

1028. The terminal uses the second ethernet MAC address as a source MAC address of a packet of the terminal.

1029. The MAMF determines that the first ethernet MAC address cannot uniquely identify the terminal or the PDU session of the terminal within the global network range.

1030. The MAMF sends a determining response to the SMF, where the determining response includes indication information. Correspondingly, the SMF receives the determining response from the MAMF.

The indication information is used to indicate that the first ethernet MAC address cannot uniquely identify the terminal or the PDU session of the terminal within the global network range.

1031. The SMF sends a PDU session establishment request reject message to the AMF. Correspondingly, the AMF receives the PDU session establishment request reject message from the SMF.

The PDU session establishment request reject message includes the indication information.

1032. The AMF sends the PDU session establishment request reject message to an AN. Correspondingly, the AN receives the PDU session establishment request reject message from the AMF.

1033. The AN sends the PDU session establishment request reject message to the terminal. Correspondingly, the terminal receives the PDU session establishment request reject message from the AN.

1034. The terminal determines, based on the PDU session establishment request reject message, that the first ethernet MAC address cannot uniquely identify the terminal or the PDU session of the terminal within the global network range.

After operation 1034, the terminal may perform any method in the methods shown in Embodiment 1 and Embodiment 2.

For example, information exchange between the network elements may be implemented by a service-oriented architecture invoking a service. For example, information exchange between the SMF and the MAMF in FIG. 9A and FIG. 9B may be implemented by a service-oriented architecture invoking a service.

The solutions provided in the embodiments of this application are mainly described above from a perspective of interaction between network elements. It may be understood that, to implement the foregoing functions, the foregoing apparatus for determining an ethernet MAC address and the foregoing apparatus for generating a bill include corresponding hardware structures and/or software modules for implementing the functions. A person skilled in the art should easily be aware that, in combination with the examples described in the embodiments disclosed in this specification, units and algorithm operations may be implemented by hardware or a combination of hardware and computer software. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of this application.

In the embodiments of this application, function modules of the apparatus for determining an ethernet MAC address and the apparatus for generating a bill may be obtained through division based on the foregoing method examples. For example, each function module may be obtained through division corresponding to each function, or two or more functions may be integrated into one processing module. The integrated module may be implemented in a form of hardware, or may be implemented in a form of a software functional module. It should be noted that, in the embodiments of this application, module division is an example, and is merely logical function division. In actual implementation, another division manner may be used.

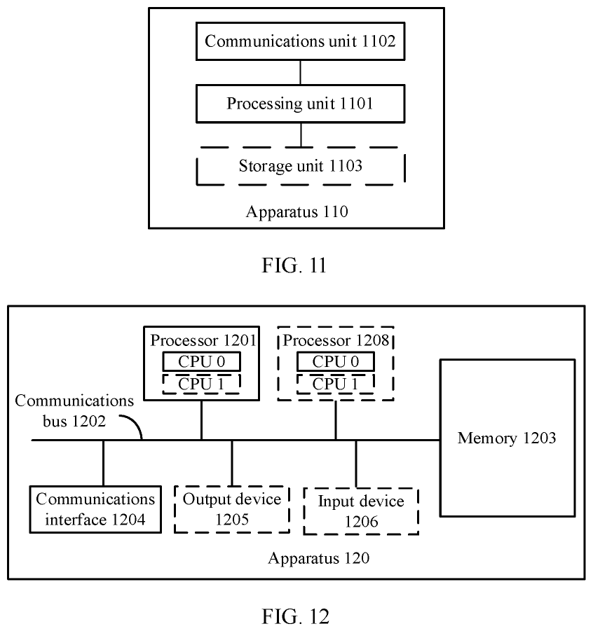

When an integrated unit is used, FIG. 11 is a possible schematic structural diagram of an apparatus 110 according to the foregoing embodiments. The apparatus 110 may be a first network device, a terminal, or an apparatus for generating a bill. The apparatus 110 includes a processing unit 1101 and a communications unit 1102, and may further include a storage unit 1103.

When the apparatus 110 is the first network device, the processing unit 1101 is configured to control and manage an action of the first network device. For example, the processing unit 1101 is configured to support the first network device in performing operations 402 to 404 in FIG. 4, operations 801 and 802 in FIG. 8, operations 904 to 907 in FIG. 9A, operations 1007 to 1009, 1018 to 1020, and 1029 and 1030 in FIG. 10A to FIG. 10E, and/or an action performed by the first network device in another process described in the embodiments of this application. The communications unit 1102 is configured to support the first network device in communicating with another network entity, for example, communicating with the terminal in FIG. 8. The storage unit 1103 is configured to store program code and data of the first network device.

When the apparatus 110 is the terminal, the processing unit 1101 is configured to control and manage an action of the terminal. For example, the processing unit 1101 is configured to support the terminal in performing operations 401, 404, and 405 in FIG. 4, operations 802 and 803 in FIG. 8, operations 901, 904, and 914 to 916 in FIG. 9A and FIG. 9B, operations 1001 and 1002, 1015 to 1017, 1026 to 1028, and 1033 and 1034 in FIG. 10A to FIG. 10E, and/or an action performed by the terminal in another process described in the embodiments of this application. The communications unit 1102 is configured to support the terminal in communicating with another network entity, for example, communicating with the first network device in FIG. 8. The storage unit 1103 is configured to store program code and data of the terminal.

When the apparatus 110 is the apparatus for generating a bill, the processing unit 1101 is configured to control and manage an action of the apparatus for generating a bill, and the processing unit 1101 is configured to support the apparatus for generating a bill in performing an action performed by the apparatus for generating a bill described in the embodiments of this application. The apparatus for generating a bill may specifically be a second network device or a third network device. When the apparatus for generating a bill is the second network device and the second network device is an SMF, the processing unit 1101 is configured to support the second network device in performing operations 902 to 905, 907 to 910, and 912 in FIG. 9A and FIG. 9B, operations 1003 to 1007, 1009 to 1011, 1013, 1020 to 1022, 1024, and 1030 and 1031 in FIG. 10A to FIG. 10E. When the apparatus for generating a bill is the third network device and the third network device is a UPF, the processing unit 1101 is configured to support the third network device in performing operations 910 and 911 in FIG. 9B, and operations 1011, 1012, 1022, and 1023 in FIG. 10A to FIG. 10E.

The processing unit 1101 may be a processor or a controller. The communications unit 1102 may be a communications interface, a transceiver, a transceiver circuit, or the like. The communications interface is a general term, and may include one or more interfaces. The storage unit 1103 may be a memory. When the processing unit 1101 is a processor, the communications unit 1102 is a communications interface, and the storage unit 1103 is a memory, the apparatus according to the embodiments of this application may be an apparatus 120 shown in FIG. 12.

The apparatus 120 includes at least one processor 1201, a communications bus 1202, a memory 1203, and at least one communications interface 1204.

The processor 1201 may be a general-purpose central processing unit (CPU), a microprocessor, an application-specific integrated circuit (ASIC), or one or more integrated circuits configured to control program execution of the solutions in this application.

The communications bus 1202 may include a channel, to transfer information between the foregoing components.

The communications interface 1204 may be any apparatus such as a transceiver, and is configured to communicate with another device or a communications network, for example, an ethernet, a RAN, or a wireless local area network (WLAN).

The memory 1203 may be a read-only memory (ROM) or another type of static storage device capable of storing static information and instructions, a random access memory (RAM) or another type of dynamic storage device capable of storing information and instructions, or may be an electrically erasable programmable read-only memory (EEPROM), a compact disc read-only memory (CD-ROM) or other compact disc storage or optical disc storage (including a compressed optical disc, a laser disc, an optical disc, a digital versatile disc, a blue-ray optical disc, and the like), a magnetic disk storage medium or another magnetic storage device, or any other medium capable of carrying or storing expected program code in a form of an instruction or a data structure and capable of being accessed by a computer, but is not limited thereto. The memory may exist independently, and is connected to the processor by using a bus. The memory may be integrated with the processor.

The memory 1203 is configured to store application program code for performing the solutions of this application, and the processor 1201 controls the execution. The processor 1201 is configured to execute the application program code stored in the memory 1203, to implement the methods provided in the foregoing embodiments of this application.

In specific implementation, in an embodiment, the processor 1201 may include one or more CPUs, for example, a CPU 0 and a CPU 1 in FIG. 12.

In specific implementation, in an embodiment, the network device 120 may include a plurality of processors, for example, the processor 1201 and a processor 1208 in FIG. 3. Each of the processors may be a single-core (single-CPU) processor, or may be a multi-core (multi-CPU) processor. Herein the processor may be one or more devices, circuits, and/or processing cores configured to process data (for example, a computer program instruction).

In specific implementation, in an embodiment, the network device 120 may further include an output device 1205 and an input device 1206.

The apparatus 120 may be a first network device, a terminal, or an apparatus for generating a bill.

When the apparatus 120 is the first network device, the processor 1201 is configured to control and manage an action of the first network device. For example, the processor 1201 is configured to support the first network device in performing operations 402 to 404 in FIG. 4, operations 801 and 802 in FIG. 8, operations 904 to 907 in FIG. 9A, operations 1007 to 1009, 1018 to 1020, and 1029 and 1030 in FIG. 10A to FIG. 10E, and/or an action performed by the first network device in another process described in the embodiments of this application. The communications interface 1204 is configured to support the first network device in communicating with another network entity, for example, communicating with the terminal in FIG. 8. The memory 1203 is configured to store program code and data of the first network device.

When the apparatus 120 is the terminal, the processor 1201 is configured to control and manage an action of the terminal. For example, the processor 1201 is configured to support the terminal in performing operations 401, 404, and 405 in FIG. 4, operations 802 and 803 in FIG. 8, operations 901, 904, and 914 to 916 in FIG. 9A and FIG. 9B, operations 1001 and 1002, 1015 to 1017, 1026 to 1028, and 1033 and 1034 in FIG. 10A to FIG. 10E, and/or an action performed by the terminal in another process described in the embodiments of this application. The communications interface 1204 is configured to support the terminal in communicating with another network entity, for example, communicating with the first network device in FIG. 8. The memory 1203 is configured to store program code and data of the terminal.

When the apparatus 120 is the apparatus for generating a bill, the processor 1201 is configured to control and manage an action of the apparatus for generating a bill, and the processor 1201 is configured to support the apparatus for generating a bill in performing an action performed by the apparatus for generating a bill described in the embodiments of this application. The apparatus for generating a bill may specifically be a second network device or a third network device. When the apparatus for generating a bill is the second network device and the second network device is an SMF, the processor 1201 is configured to support the second network device in performing operations 902 to 905, 907 to 910, and 912 in FIG. 9A and FIG. 9B, operations 1003 to 1007, 1009 to 1011, 1013, 1020 to 1022, 1024, and 1030 and 1031 in FIG. 10A to FIG. 10E. When the apparatus for generating a bill is the third network device and the third network device is a UPF, the processor 1201 is configured to support the third network device in performing operations 910 and 911 in FIG. 9B, and operations 1011, 1012, 1022, and 1023 in FIG. 10A to FIG. 10E.

An embodiment of this application further provides a computer-readable storage medium, including an instruction. When the instruction is run on a computer, the computer is enabled to perform the foregoing methods.

An embodiment of this application further provides a computer program product including an instruction. When the computer program product is run on a computer, the computer is enabled to perform the foregoing methods.

All or some of the foregoing embodiments may be implemented by using software, hardware, firmware, or any combination thereof. When a software program is used to implement the embodiments, the embodiments may be implemented completely or partially in a form of a computer program product. The computer program product includes one or more computer instructions. When the computer program instructions are loaded and executed on a computer, the procedure or functions according to the embodiments of this application are completely or partially generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, a solid-state drive (SSD)), or the like.

Although this application is described with reference to the embodiments, in a process of implementing this application that claims protection, a person skilled in the art may understand and implement another variation of the disclosed embodiments by viewing the accompanying drawings, disclosed content, and the accompanying claims. In the claims, “comprising” does not exclude another component or another operation, and “a” or “one” does not exclude a meaning of plurality. A single processor or another unit may implement several functions enumerated in the claims. Some measures are recorded in dependent claims that are different from each other, but this does not mean that these measures cannot be combined to produce a better effect.

Although this application is described with reference to specific features and the embodiments thereof, clearly, various modifications and combinations may be made to them without departing from the spirit and scope of this application. Correspondingly, the specification and accompanying drawings are merely example description of this application defined by the accompanying claims, and is considered as any of or all modifications, variations, combinations or equivalents that cover the scope of this application. Clearly, a person skilled in the art can make various modifications and variations to this application without departing from the spirit and scope of this application. This application is intended to cover these modifications and variations of this application provided that they fall within the scope of protection defined by the claims of this application and their equivalent technologies.

What is claimed is:

1. An apparatus comprising:
a processor, configured to allocate a first ethernet media access control (MAC) address to a terminal, wherein the first ethernet MAC address uniquely identifies the terminal or a packet data unit (PDU) session of the terminal within a global network range; and
a transceiver, configured to send the first ethernet MAC address to the terminal, wherein the first ethernet MAC address is a source MAC address of a packet sent by the terminal.

2. The apparatus according to claim 1, wherein
the transceiver is further configured to receive a second ethernet MAC address from the terminal; and
the processor is further configured to determine that the second ethernet MAC address does not uniquely identify the terminal or the PDU session of the terminal within the global network range.

3. The apparatus according to claim 1, wherein
the transceiver is further configured to send the first ethernet MAC address to a network device, wherein the first ethernet MAC address is used to establish a correspondence between the first ethernet MAC address and an identifier of a subscriber corresponding to the terminal.

4. The apparatus according to claim 1, wherein
the processor is further configured to establish a correspondence between the first ethernet MAC address and an identifier of a subscriber corresponding to the terminal; and
the transceiver is further configured to send the correspondence to a network device, wherein the correspondence is used for a generation of a bill of the subscriber.

5. The apparatus according to claim 1, wherein
the processor is further configured to set that the first ethernet MAC address in an ethernet MAC address database cannot be allocated.

6. The method according to claim 1, wherein a type of the PDU session of the terminal is an ethernet type.

7. A method comprising:
receiving, by a terminal, a first ethernet media access control (MAC) address from a first network device, wherein the first ethernet MAC address uniquely identifies the terminal or a packet data unit PDU session of the terminal within a global network range; and
sending, by the terminal, a packet, wherein a source MAC address of the packet is the first ethernet MAC address.

8. The method according to claim 7, wherein a type of the PDU session of the terminal is an ethernet type.

9. An apparatus comprising:
a receiver, configured to receive a first ethernet media access control (MAC) address from a first network device, wherein the first ethernet MAC address uniquely identifies the apparatus or a packet data unit (PDU) session of the apparatus within a global network range; and
a transmitter, configured to send a packet, wherein a source MAC address of the packet is the first ethernet MAC address.

10. The apparatus according to claim 9, wherein a type of the PDU session of the apparatus is an ethernet type.
